(19) United States
(12) Patent Application Publication
(10) Pub. No.: US 2009/0184641 A1
(43) Pub. Date: Jul. 23, 2009

(54) Plasma display panel

(76) Inventor: Sung-Hune Yoo, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/320,204

(22) Filed: Jan. 21, 2009

(30) Foreign Application Priority Data
Jan. 23, 2008 (KR) 10-2008-0007075

(51) Int. Cl. H01J 17/49

(52) U.S. Cl. 313/586

(57) ABSTRACT

A plasma display panel (PDP) having improved impact resistance, the PDP including: a front substrate on which sustain electrodes are disposed at predetermined intervals; a front dielectric layer covering the sustain electrodes; a rear substrate that is disposed to face the front substrate, and on which address electrodes are disposed to cross the sustain electrodes; a rear dielectric layer covering the address electrodes; barrier ribs formed between the front substrate and the rear substrate, the barrier ribs defining discharge spaces; and phosphor layers formed in the discharge spaces, wherein the front dielectric layer has a Vickers hardness of 350 to 500 Hv.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 23 Jan. 2008 and there duly assigned Serial No. 10-2008-0007075.

### BACKGROUND OF THE INVENTION

1. Field of the Invention

The present invention relates to a plasma display panel (PDP), and more particularly, to a PDP which has an improved impact resistant lead-free front dielectric layer.

2. Description of the Related Art

Plasma display panels (PDPs) can be easily used to form large screen displays, and have good display qualities due to their self-emission and quick response characteristics. In addition, PDPs can be formed to be thin, and thus, like LCDs, are suitable as wall-mounted displays.

In PDPs, a glow discharge occurs when a predetermined voltage is applied to two electrodes formed in a closed space where a discharge gas is filled, and thus, the PDPs display images by the exciting of phosphor layers, formed in a predetermined pattern, with ultraviolet rays that are generated from the glow discharge.

PDPs can be classified into direct current (DC) type PDPs, alternating current (AC) type PDPs, and hybrid-type PDPs according to driving methods. PDPs can be further classified into two-electrode type PDPS and three-electrode type PDPS. A DC PDP includes an auxiliary anode in order to induce auxiliary discharge. An AC PDP includes address electrodes that increase addressing speed by performing an address discharge and a sustain discharge separately.

AC PDPs can be classified into those with an opposing discharge electrode structure and those with a surface discharge electrode structure according to the arrangement of electrodes, which form discharge. In the opposing discharge electrode structure, a discharge occurs in a direction perpendicular to the PDP by disposing two sustain electrodes which form discharge on a front substrate and a rear substrate, respectively. In the surface discharge electrode structure, a discharge occurs on one surface of a substrate by having two sustain electrodes on the same substrate.

However, due to recent environmental regulations, dielectric components used in the PDP are typically required to be a lead-free material. However, in this case, due to the thermal expansion coefficient and hardness of the dielectric, a PDP including such a dielectric can be easily broken by external impact. In addition, such a problem is more likely to occur if a filter is directly attached to the PDP and a thin rear substrate or front substrate is applied in the PDP.

Therefore, it is an object of the present invention to provide for a lead-free dielectric which has good impact resistance.

### SUMMARY OF THE INVENTION

The present invention provides a plasma display panel (PDP) having improved impact resistance, in which a front dielectric layer has a Vickers hardness of 350 to 500 Hv.

The present invention also provides a PDP having improved impact resistance, in which a front dielectric layer has a Vickers hardness of 350 to 500 Hv, and a difference between the thermal expansion coefficients of the front dielectric layer and a front substrate is in a range of 10 to 15×10⁻⁷/° C.

According to an aspect of the present invention, there is provided a plasma display panel (PDP) comprising: a front substrate on which sustain electrodes are disposed at a predetermined interval; a front dielectric layer covering the sustain electrodes; a rear substrate that is disposed to face the front substrate, and on which address electrodes are disposed to cross the sustain electrodes; a rear dielectric layer covering the address electrodes; barrier ribs formed between the front substrate and the rear substrate, the barrier ribs defining discharge spaces; and phosphor layers formed in the discharge spaces, wherein the front dielectric layer has a Vickers hardness of 350 to 500 Hv.

The front dielectric layer may comprise at least two selected from the group consisting of B₂O₃, SiO₂, Bi₂O₃, ZnO, and Al₂O₃.

The front dielectric layer may comprise at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

The front dielectric layer may comprise at least two selected from the group consisting of B₂O₃, SiO₂, BaO, ZnO, Al₂O₃, P₂O₅.

The front dielectric layer may comprise at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.

According to another aspect of the present invention, there is provided a PDP comprising: a front substrate on which sustain electrodes are disposed at a predetermined interval; a front dielectric layer covering the sustain electrodes; a rear substrate that is disposed to face the front substrate, and on which address electrodes are disposed to cross the sustain electrodes; a rear dielectric layer covering the address electrodes; barrier ribs formed between the front substrate and the rear substrate, the barrier ribs defining discharge spaces; and phosphor layers formed in the discharge spaces, wherein the front dielectric layer has a Vickers hardness of 350 to 500 Hv, a difference between the thermal expansion coefficients of the front dielectric layer and the front substrate is in a range of 10 to 15×10⁻⁷/° C.

The front dielectric layer may comprise at least two selected from the group consisting of B₂O₃, SiO₂, Bi₂O₃, ZnO, and Al₂O₃.

The front dielectric layer may comprise at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

The front dielectric layer may comprise at least two selected from the group consisting of B₂O₃, SiO₂, BaO, ZnO, Al₂O₃, P₂O₅.

The front dielectric layer may comprise at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a cross-sectional view of a contemporary plasma display panel (PDP); and

FIG. 2 is a graph showing ball drop test results of PDPs manufactured in Examples 1 through 4 and Comparative Example 1 and showing the Vickers hardness of a front dielectric layer used in each of the PDPs.

### DETAILED DESCRIPTION OF THE INVENTION

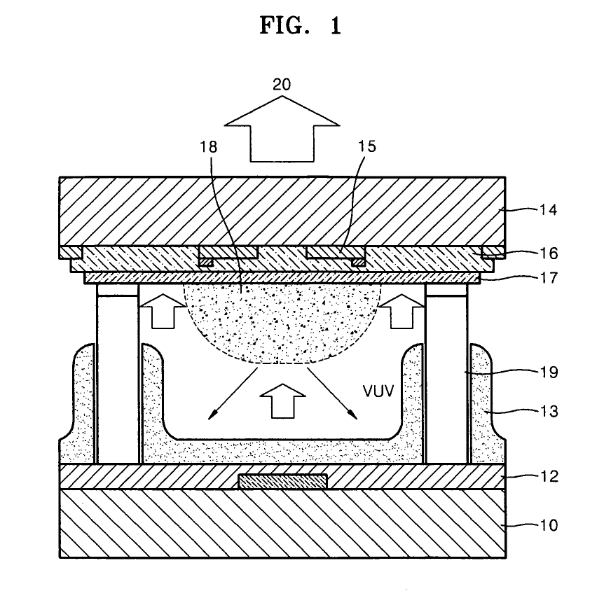

FIG. 1 is a cross-sectional view of a contemporary PDP in which this PDP includes a front substrate 14 at an upper part thereof, and pairs of sustain electrodes 15, each of which has a predetermined width and height and comprises a common electrode and a scan electrode, wherein the sustain electrodes 15 are formed on a bottom surface of the front substrate 14.

A pair of bus electrodes to which a voltage is applied are respectively formed on a bottom surface of the pair of sustain electrodes 15. The sustain electrodes 15 and the bus electrodes are covered by a front dielectric layer 16, and a protective layer 17 is formed on a bottom surface of the front dielectric layer 16.

In addition, a rear substrate 10 is disposed to face the front substrate 14, and address electrodes 11 having a predetermined width and height are formed on the rear substrate 10. The address electrodes 11 are covered by a rear dielectric layer 12.

In addition, barrier ribs 19, which define discharge spaces and prevent crosstalk between adjacent discharge spaces, are formed on a top surface of the rear dielectric layer 12. The discharge spaces are filled with discharge gases, and a phosphor layer 13 formed of red, green or blue phosphor is formed in each of the discharge spaces in order to realize colors.

In addition, when an AC voltage that is applied between the pair of sustain electrodes 15, which form discharge sustain electrode poles, reaches a discharge initiation voltage, an electric force line is generated and an inert gas is dissociated into electrons and ions by the electric force line. Then, the electrons and ions are recombined to emit ultraviolet (UV) rays and the phosphor layer 13 excited by the UV rays emits visible light.

Due to recent environmental regulations, a dielectric used in the front dielectric layer 16 is typically a lead-free material. However, in this case, due to the thermal expansion coefficient and hardness of the dielectric, a PDP including such a dielectric can be easily broken by external impact. In addition, such a problem is more likely to occur if a filter is directly attached to the PDP and a thin rear substrate or front substrate is applied in the PDP.

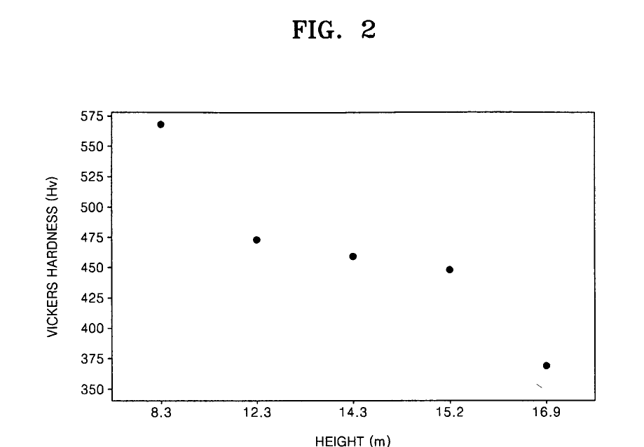

The present invention will now be described more fully with reference to FIG. 2.

The present invention provides a plasma display panel (PDP) including: a front substrate on which sustain electrodes are disposed at predetermined intervals; a front dielectric layer covering the sustain electrodes; a rear substrate that is disposed to face the front substrate, and on which address electrodes are disposed to cross the sustain electrodes; a rear dielectric layer covering the address electrodes; barrier ribs formed between the front substrate and the rear substrate, the barrier ribs defining discharge spaces; and phosphor layers formed in the discharge spaces, wherein the front dielectric layer has a Vickers hardness of 350 to 500 Hv.

Vickers hardness is obtained by placing a pyramid-shaped diamond press with an angle of 136° between opposite faces on the surface of a material and lightly pressing it onto the material to form a pit, removing the load, and then dividing the load by a surface area of the remaining permanent pit. The Vickers hardness is represented by an equation, Hv=P/S where P is the load in kg, and S is the surface area in mm². The Vickers hardness has advantages in that it can be directly compared with other values measured using load, and the Vickers hardness of products can be directly measured.

A front dielectric layer having a Vickers hardness of less than 350 Hv cannot be prepared using a contemporary lead-free material. In this regard, lead-free materials have a Vickers hardness (Hv) of 500 Hv or more, thus having high brittleness. When a front dielectric layer formed of such a contemporary lead-free material is applied in a PDP, impact resistance properties of the PDP deteriorate, and the thermal expansion coefficient of the front dielectric layer is high, and thus the PDP can be easily bent. Accordingly, the front substrate of the PDP (for example, glass) can be easily broken.

The front dielectric layer of the PDP according to an embodiment of the present invention may comprise at least two selected from the group consisting of B₂O₃, SiO₂, Bi₂O₃, ZnO, and Al₂O₃. In particular, the front dielectric layer may comprise at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

In the composition ranges described above, the front dielectric layer of the PDP according to the current embodiment of the present invention has a Vickers hardness of 350 to 500 Hv.

According to another embodiment of the present invention, the front dielectric layer of the PDP may comprise at least two selected from the group consisting of B₂O₃, SiO₂, BaO, ZnO, Al₂O₃, and P₂O₅. In particular, the front dielectric layer may comprise at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.

In the composition ranges described above, the front dielectric layer of the PDP according to the current embodiment of the present invention has a Vickers hardness of 350 to 500 Hv.

The front substrate of the PDP may be a glass substrate.

The present invention also provides a PDP including: a front substrate on which sustain electrodes are disposed at predetermined intervals; a front dielectric layer covering the sustain electrodes; a rear substrate that is disposed to face the front substrate, and on which address electrodes are disposed to cross the sustain electrodes; a rear dielectric layer covering the address electrodes; barrier ribs formed between the front substrate and the rear substrate, the barrier ribs defining discharge spaces; and phosphor layers formed in the discharge spaces, wherein the front dielectric layer has a Vickers hardness of 350 to 500 Hv, and a difference between the thermal expansion coefficients of the front dielectric layer and the front substrate is in a range of 10 to 15×10⁻⁷/° C.

When the Vickers hardness of the front dielectric layer is less than 350 Hv, the front dielectric layer cannot be prepared using a contemporary lead-free material. When the Vickers hardness of the front dielectric layer is greater than 500 Hv, the front dielectric layer has high brittleness, and thus the impact resistance properties of the PDP deteriorates. When the front dielectric layer has a Vickers hardness in the range described above, a difference between the thermal expansion coefficients of the front dielectric layer and the front substrate is in a range of 10 to 15×10⁷/° C. Thus, the residual stress of the front substrate is minimized and a compressive stress also acts on the front dielectric layer.

The front dielectric layer of the PDP according to the current embodiment of the present invention may comprise at least two selected from the group consisting of B₂O₃, SiO₂, Bi₂O₃, ZnO, and Al₂O₃. In particular, the front dielectric layer may comprise at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

In the composition ranges described above, the front dielectric layer of the PDP according to the current embodiment of the present invention has a Vickers hardness of 350 to 500 Hv, and the difference between the thermal expansion coefficients of the front dielectric layer and the front substrate is in a range of 10 to 15×10⁻⁷/° C.

According to another embodiment of the present invention, the front dielectric layer of the PDP may comprise at least two selected from the group consisting of B₂O₃, SiO₂, BaO, ZnO, Al₂O₃, and P₂O₅. In particular, the front dielectric layer may comprise at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.

In the composition ranges described above, the front dielectric layer of the PDP according to the current embodiment of the present invention has a Vickers hardness of 350 to 500 Hv, and the difference between the thermal expansion coefficients of the front dielectric layer and the front substrate is in a range of 10 to 15×10⁻⁷/° C.

Hereinafter, a front dielectric layer of a PDP according to the present invention and a PDP including the same will be described in further detail with reference to the following examples. These examples are for illustrative purposes only and are not intended to limit the scope of the present invention.

### EXAMPLE

### Preparation of Dielectric Slurry 1

Ethyl cellulose as a binder was dissolved in a mixed solvent of butyl carbitol acetate and terpineol in a mixing ratio of 3:7. Then, a glass component comprising 13 mol % of Bi₂O₃, 12 mol % of SiO₂, 40 mol % of B₂O₃, 13 mol % of Al₂O₃, and 22 mol % of ZnO was added to the mixed solvent in which the binder was dissolved and mixed together to prepare a dielectric slurry 1 having a solid content of 75%.

### Preparation of Dielectric Slurry 2

Ethyl cellulose as a binder was dissolved in a mixed solvent of butyl carbitol acetate and terpineol in a mixing ratio of 3:7. Then, a glass component comprising 10 mol % of Bi₂O₃, 5 mol % of SiO₂, 40 mol % of B₂O₃, 35 mol % of ZnO, and 10 mol % of Al₂O₃ was added to the mixed solvent in which the binder was dissolved and mixed together to prepare a dielectric slurry 2 having a solid content of 75%.

### Preparation of Dielectric Slurry 3

Ethyl cellulose as a binder was dissolved in a mixed solvent of butyl carbitol acetate and terpineol in a mixing ratio of 3:7. Then, a glass component comprising 20 mol % of SiO₂, 30 mol % of B₂O₃, and 50 mol % of ZnO was added to the mixed solvent in which the binder was dissolved and mixed together to prepare a dielectric slurry 3 having a solid content of 75%.

### Preparation of Dielectric Slurry 4

Ethyl cellulose as a binder was dissolved in a mixed solvent of butyl carbitol acetate and terpineol in a mixing ratio of 3:7. Then, a glass component comprising 35 mol % of SiO₂, 30 mol % of B₂O₃, 15 mol % of ZnO, and 20 mol % of P₂O₅ was added to the mixed solvent in which the binder was dissolved and mixed together to prepare a dielectric slurry 4 having a solid content of 75%.

### Manufacture of Front Substrate 1 for a PDP

The prepared dielectric slurry 1 was coated on an electrode layer formed on a glass substrate to form a front dielectric layer 1 having a thickness of 30 μm. The front dielectric layer 1 was transparent.

An MgO protective layer was formed on the dielectric layer 1 by physical vapor deposition (PVD) to manufacture a front substrate 1.

### Manufacture of Front Substrate 2 for a PDP

A front substrate 2 was manufactured using the same method as that used to manufacture the front substrate 1 for a PDP, except that a front dielectric layer 2 formed using the prepared dielectric slurry 2 was used.

### Manufacture of Front Substrate 3 for a PDP

A front substrate 3 was manufactured using the same method as that used to e manufacture the front substrate 1 for a PDP, except that a front dielectric layer 3 formed using the prepared dielectric slurry 3 was used.

### Manufacture of Front Substrate 4 for a PDP

A front substrate 4 was manufactured using the same method as that used to manufacture the front substrate 1 for a PDP, except that a front dielectric layer 4 formed using the prepared dielectric slurry 4 was used.

### Manufacture of a Rear Substrate

6 parts by weight of ethyl cellulose as a binder was dissolved in 100 parts by weight of a mixed solvent of butyl carbitol acetate and terpineol with a mixing weight ratio of 3:7, and BaMgAl₁₀O₁₇:Eu as a blue phosphor was added thereto and mixed together to prepare a phosphor slurry. The prepared phosphor slurry was coated on inner walls of discharge cells defined by barrier ribs disposed on a first substrate, and then, the first substrate, coated with the phosphor slurry, was dried and sintered at 120° C. to form a blue phosphor layer.

In addition, phosphor layers formed of (Y,Gd)BO₃:Eu and phosphor layers formed of ZnSiO₄:Mn were respectively formed in red discharge cells and green discharge cells using the same method as that used to form the blue phosphor layer described above. As a result, the manufacture of a rear substrate was completed.

### Example 1

### Assembly of Panel 1

The rear substrate and the front substrate 1 were assembled, joined together to form a discharge space, the discharge space was vacuumed, gases were injected into the discharge space, and then the structure was aged, thereby manufacturing a PDP 1.

### Example 2

### Assembly of Panel 2

A PDP 2 was manufactured in the same manner as in Example 1, except that the front substrate 2 was used.

### Example 3

### Assembly of Panel 3

A PDP 3 was manufactured in the same manner as in Example 1, except that the front substrate 3 was used.

### Example 4

### Assembly of Panel 4

A PDP 4 was manufactured in the same manner as in Example 1, except that the front substrate 4 was used.

### Comparative Example

### Preparation of Dielectric Slurry 5

Ethyl cellulose as a binder was dissolved in a mixed solvent of butyl carbitol acetate and terpineol in a mixing ratio of 3:7. Then, a glass component comprising 10 mol % of SiO₂, 41 mol % of B₂O₃, 22 mol % of BaO, and 27 mol % of PbO was added to the mixed solvent in which the binder was dissolved and mixed together to prepare a dielectric slurry 5 having a solid content of 75%.

### Manufacture of Front Substrate 5 for a PDP

A front substrate 5 was manufactured using the same method as that used to manufacture the front substrate 1 for a PDP, except that a front dielectric layer 5 formed using the prepared dielectric slurry 5 was used.

### Comparative Example 1

### Assembly of Panel 5

A PDP 5 was manufactured in the same manner as in Example 1, except that the front substrate 5 was used.

The Vickers hardness of each of the front dielectric layers 1 through 5 of the respective front substrates 1 through 5 for a PDP was measured. The Vickers hardness was measured using a HV-112 manufactured by Mitutoyo in accordance with KS B 0811.

Impact resistances of the PDPs 1 through 5 of Examples 1 through 4 and Comparative Example 1, respectively, were measured using a ball drop test. The results are shown in Table 1 below.

The ball drop test according to JIS R 3212 was measured as follows.

The measurement was performed by dropping a ball having a weight of 2260 g and a diameter of 82 mm at a center portion of each of the PDPs 1 through 5 of Examples 1 through 4 and Comparative Example 1. A height (cm) at which the ball was dropped from to break each of the PDPs 1 through 5 was measured.

In addition, the thermal expansion coefficients of the front substrates 1 through 5 and the front dielectric layers 1 through 5 of the PDPs 1 through 5 of Examples 1 through 4 and Comparative Example 1 were measured, and also a difference between the thermal expansion coefficients was measured. The results are shown in Table 1 below. The thermal expansion coefficient was measured according to ASTM E 831, ASTM D 696, and ASTM D 3386, and the thermal expansion rate was measured using a dilatometer at a temperature ranging from 50° C. to 350° C.

TABLE 1

| | | | | | Comparative |
|---|---|---|---|---|---|
| | Example 1 | Example 2 | Example 3 | Example 4 | Example 1 |
| Vickers hardness (Hv)¹⁾ | 477 | 463 | 442 | 375 | 568 |
| height (cm)²⁾ | 12.3 | 14.3 | 15.2 | 16.9 | 8.3 |
| Thermal expansion | 85 | 85 | 58 | 85 | 85 |
| coefficient of front | | | | | |
| substrate³⁾ (×10⁻⁷/K) | | | | | |
| Thermal expansion | 75 | 71 | 70 | 70 | 81 |
| coefficient of front | | | | | |
| dielectric layer⁴⁾ (×10⁻⁷/K) | | | | | |
| Difference between | 10 | 14 | 15 | 15 | 4 |
| thermal expansion | | | | | |
| coefficients of front | | | | | |
| substrate and front | | | | | |
| dielectric layer (1/° C.) | | | | | |

¹⁾represents to the Vickers hardness of the front dielectric layers 1 through 5 of the PDPs 1 through 5 of Examples 1 through 4 and Comparative Example 1.
²⁾represents the height at which a ball is dropped from to break the PDPs 1 through 5 of Examples 1 through 4 and Comparative Example 1 using a ball drop test.
³⁾represents the thermal expansion coefficient of the front substrates 1 through 5 of the PDPs 1 through 5 of Examples 1 through 4 and Comparative Example 1.
⁴⁾represents the thermal expansion coefficient of the front dielectric layers 1 through 5 of the PDPs 1 through 5 of Examples 1 through 4 and Comparative Example 1.

FIG. 2 is a graph showing ball drop test results of the PDPs 1 through 5 of Examples 1 through 4 and Comparative Example 1 and showing the Vickers hardness of the front dielectric layers 1 through 5 used in the PDPs 1 through 5.

Referring to FIG. 2, the PDPs 1 through 4 (Examples 1 through 4) including the front dielectric layers 1 through 4 having a Vickers hardness of 350 to 500 Hv have improved impact resistance, as compared to the PDP 5 of Comparative Example 1.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP) comprising:
a front substrate on which sustain electrodes are disposed at predetermined intervals;
a front dielectric layer covering the sustain electrodes;
a rear substrate that is disposed to face the front substrate, and on which address electrodes are disposed to cross the sustain electrodes;
a rear dielectric layer covering the address electrodes;
barrier ribs formed between the front substrate and the rear substrate, the barrier ribs defining discharge spaces; and
phosphor layers formed in the discharge spaces,
wherein the front dielectric layer has a Vickers hardness of 350 to 500 Hv.

2. The PDP of claim 1, wherein the front dielectric layer comprises at least two selected from the group consisting of B₂O₃, SiO₂, Bi₂O₃, ZnO, and Al₂O₃.

3. The PDP of claim 1, wherein the front dielectric layer comprises at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

4. The PDP of claim 1, wherein the front dielectric layer comprises at least two selected from the group consisting of B₂O₃, SiO₂, BaO, ZnO, Al₂O₃, P₂O₅.

5. The PDP of claim 1, wherein the front dielectric layer comprises at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.

6. A PDP comprising:
a front substrate on which sustain electrodes are disposed at predetermined intervals;
a front dielectric layer covering the sustain electrodes;
a rear substrate that is disposed to face the front substrate, and on which address electrodes are disposed to cross the sustain electrodes;
a rear dielectric layer covering the address electrodes;
barrier ribs formed between the front substrate and the rear substrate, the barrier ribs defining discharge spaces; and
phosphor layers formed in the discharge spaces,
wherein the front dielectric layer has a Vickers hardness of 350 to 500 Hv, and a difference between the thermal expansion coefficients of the front dielectric layer and the front substrate is in a range of 10 to 15×10⁻⁷/° C.

7. The PDP of claim 6, wherein the front dielectric layer comprises at least two selected from the group consisting of B₂O₃, SiO₂, Bi₂O₃, ZnO, and Al₂O₃.

8. The PDP of claim 6, wherein the front dielectric layer comprises at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

9. The PDP of claim 6, wherein the front dielectric layer comprises at least two selected from the group consisting of B₂O₃, SiO₂, BaO, ZnO, Al₂O₃, P₂O₅.

10. The PDP of claim 6, wherein the front dielectric layer comprises at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.

11. A plasma display panel (PDP) having a front substrate on which sustain electrodes are disposed, a rear substrate on which address electrodes are disposed, a rear dielectric layer covering the address electrodes, a plurality of barrier ribs formed between the front substrate and the rear substrate, a phosphor layers formed in a plurality of discharge spaces formed by the plurality of barrier ribs, comprising:
a front dielectric layer covering the sustain electrodes,
wherein the front dielectric layer has a Vickers hardness of no less than 350 Hv to no more than 500 Hv.

12. The PDP as recited in claim 11, wherein a difference between the thermal expansion coefficients of the front dielectric layer and the front substrate is in a range of 10 to 15×10⁻⁷/° C.

13. The PDP as recited in claim 11, wherein the front dielectric layer comprises at least two selected from the group consisting of B₂O₃, SiO₂, Bi₂O₃, ZnO, and Al₂O₃.

14. The PDP as recited in claim 11, wherein the front dielectric layer comprises at least two selected from the group consisting of 10 to 40 mol % of B₂O₃, 0 to 12 mol % of SiO₂, 8 to 13 mol % of Bi₂O₃, 10 to 35 mol % of ZnO, and 4 to 13 mol % of Al₂O₃.

15. The PDP as recited in claim 11, wherein the front dielectric layer comprises at least two selected from the group consisting of B₂O₃, SiO₂, BaO, ZnO, Al₂O₃, P₂O₅.

16. The PDP as recited in claim 11, wherein the front dielectric layer comprises at least two selected from the group consisting of 20 to 50 mol % of B₂O₃, 2 to 37 mol % of SiO₂, 0 to 15 mol % of BaO, 10 to 50 mol % of ZnO, 0 to 8 mol % of Al₂O₃, and 0 to 20 mol % of P₂O₅.
